(19) United States
(12) Patent Application Publication
(10) Pub. No.: US 2007/0088878 A1
(43) Pub. Date: Apr. 19, 2007

(54) USB storage device

(76) Inventor: Jin S. Wang, Hukou Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/252,553

(22) Filed: Oct. 19, 2005

(51) Int. Cl. G06F 13/12

(52) U.S. Cl. 710/74

(57) ABSTRACT

A USB storage device is proposed, in which a circuit layer, a USB interface, a plurality of passive components, and a memory die are disposed on a board. The passive components, the USB interface, and the memory die are electrically connected to the circuit layer. A package layer then covers the memory die, the passive components, and the circuit layer with the USB interface exposed to the outside. The volume of original USB portable storages can thus be greatly reduced to enhance the convenience of portability and expand the range of applications.

### BACKGROUND OF THE INVENTION

1. Field of the Invention

The present invention relates to a storage device and, more particularly, to a compact USB storage device with convenient portability.

2. Description of Related art

Existent portable data storage media include 1.44-MB floppy disks, recordable optical disks, memory cards and card readers, and universal serial bus (USB) portable storages, among which the USB portable storages are the most convenient and practical due to their readable/writable and plug-and-play characteristics. The USB portable storages are suitable to mobile electronic commerce and data storage and applications, and have a very high market share. Because of keen competition in this market, each manufacturer does all he can to develop better and better products to meet market demand. As shown in FIG. 1, a conventional portable storage comprises a shell body 10 with a plurality of memories and a matched circuit board therein. The circuit board is also connected with a USB connector 12. A lid 14 can cover the USB connector 12. The lid 14 is sleeved with the shell body 10. When in use, the lid 14 can be detached from the USB connector 12 so that the USB connector 12 can be inserted into a corresponding slot of an electronic device for transmission and storage of data.

Existent portable storages, however, differ in their lengths because of different designs, ranging from 40 mm to 60 mm. Their width at least exceeds 14 mm. An existent portable storage has a large volume because one or several standard flash memories with a length of about 20 mm and a width of about 12 mm are disposed in the shell body of the portable storage. The width of the shell body of the portable storage is thus about 14 mm to 16 mm. Moreover, because the width of the USB connector itself is 12 mm, the portable storage has an appearance with a small head and a fat body. Therefore, the conventional portable storage is not pleasing to the eye and has a large volume to be inconvenient for portability.

Accordingly, the present invention aims to propose a USB storage device to effectively solve the above problems in the prior art.

### SUMMARY OF THE INVENTION

On object of the present invention is to provide a USB storage device, in which a memory die instead of a packaged memory chip is directly disposed on a substrate to greatly reduce the volume of the storage device.

Another object of the present invention is to provide a USB storage device whose volume is greatly reduced to enhance the convenience of portability.

Another object of the present invention is to provide a USB storage device whose volume is greatly reduced to expand the range of applications of the storage device.

According to the present invention, a USB storage device comprises a substrate with a circuit layer, a USB interface, a plurality of passive components, and at least a memory die disposed thereon. The circuit layer is electrically connected to the USB interface. The passive components and the memory die are electrically connected to the circuit layer. A package layer is also provided to cover the memory die, the passive components and the circuit layer with the USB interface exposed to the outside.

### BRIEF DESCRIPTION OF THE DRAWINGS

The various objects and advantages of the present invention will be more readily understood from the following detailed description when read in conjunction with the appended drawing, in which:

FIG. 1 is a perspective view of a conventional portable storage;

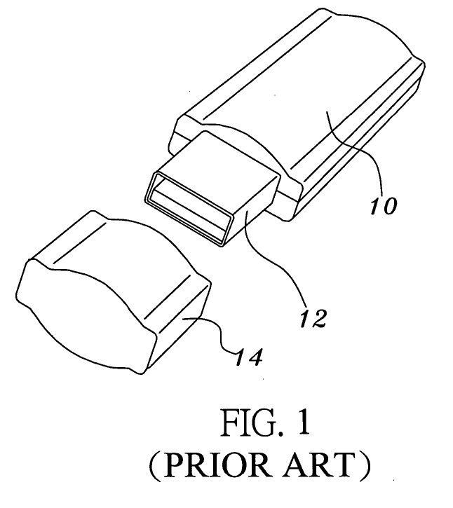

FIG. 2 is a perspective view of the present invention; and

FIG. 3 is a cross-sectional view of the present invention.

### DETAILED DESCRIPTION OF THE PREFERRED EMBODIMENTS

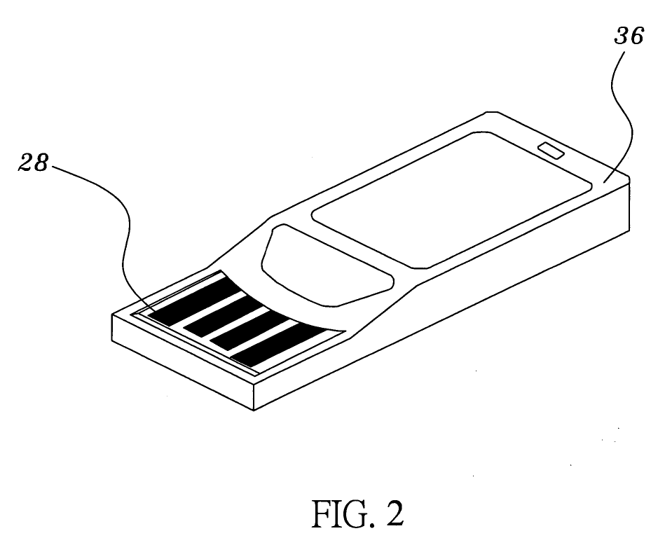

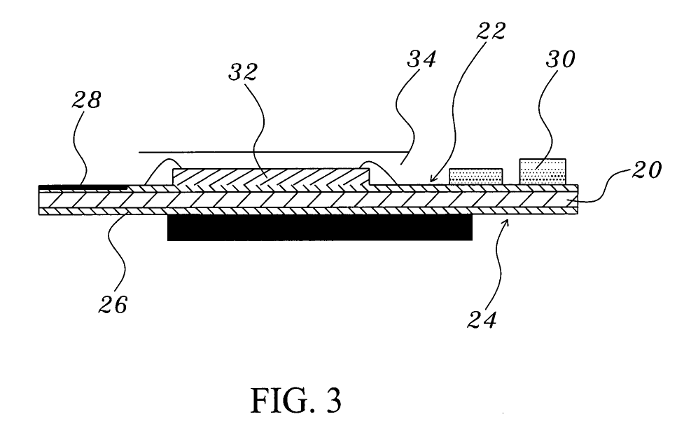

The present invention provides a USB storage device, which can be connected to a USB connector of a computer for transmission and storage of data. As shown in FIGS. 2 and 3, the USB storage device comprises a substrate 20. The substrate 20 is an FR4 (fiberglass reinforced plastic) board or an FR5 (fiberglass reinforced epoxy resin) board. The substrate 20 has a first surface 22 and a second surface 24. A circuit layer 26 is disposed on the first surface 22 and the second surface 24. A USB interface 28 is electrically connected to the circuit layer 26. A plurality of passive components 30 is disposed on the first surface 22 by means of surface mount technology (SMT). The passive components 30 can be selected among resistor, capacitor, inductor, and transformer. The passive components 30 are electrically connected to the circuit layer 26. A memory die 32 is respectively disposed on the first surface 22 and the second surface 24. The memory die 32 achieves electric connection with the circuit layer 26 in the substrate 20 by means of wire bonding or flip chip.

Next, the memory die 32, the passive components 30, and the circuit layer 26 is covered with a package layer 34 made of epoxy resin. The USB interface 28 is not covered with the package layer 34 but is exposed to the outside. Finally, the packaged structure is received in a shell body 36 with the USB interface 28 exposed to the outside for connection with a USB connector of a computer for storage of data. Besides, the USB interface 28 has no conventional USB protection housing to reduce the occupied volume of the USB interface 28.

In the USB storage device, the memory die 32 is directly disposed on the substrate 20, different from the prior art in which a packaged memory is disposed on a substrate. The original length of about 40 mm to 60 mm and the original width of at least 14 mm can thus be shrunk to a length of about 32 mm and a width of about 12 mm. Moreover, because the USB interface 28 has no conventional USB protection housing, the volume of the storage device can be further reduced. Because the volume of the USB storage device of the present invention is greatly reduced, the convenience of portability can be enhanced, and the range of applications can be expanded. The appearance of the USB storage device can also be varied to be rectangular, mobile phone shaped, egg-shaped, or arc-shaped. Furthermore, the USB storage device can have a length of 32 mm consistent with that of existent secure digital (SD) cards so that it can be placed in a mini box.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A USB storage device comprising:
a substrate having a circuit layer and a USB interface, said circuit layer being connected with said USB interface, a plurality of passive components being disposed on said substrate and electrically connected to said circuit layer;
at least a memory die disposed on said substrate and electrically connected to said circuit layer; and
a package layer for covering said passive components and said circuit layer with said USB interface exposed to the outside.

2. The USB storage device as claimed in claim 1, wherein said memory die is electrically connected to said circuit layer by means of wire bonding or flip chip.

3. The USB storage device as claimed in claim 1, wherein said passive components can be selected among resistor, capacitor, inductor, or transformer.

4. The USB storage device as claimed in claim 1, wherein said passive components are disposed on said substrate by means of surface mount technology.

5. The USB storage device as claimed in claim 1, wherein said substrate is an FR4 board or an FR5 board.

6. The USB storage device as claimed in claim 1, further comprising a shell body, wherein said substrate, said passive components, and said memory die are received in said shell body, and said USB interface is exposed out of said shell body.

7. The USB storage device as claimed in claim 1, wherein said package layer is made of epoxy resin.
